(19) United States
(12) Patent Application Publication
(10) Pub. No.: US 2021/0399281 A1
(43) Pub. Date: Dec. 23, 2021

(54) ALKALINE BATTERY CATHODE WITH SOLID POLYMER ELECTROLYTE

(71) Applicant: Ionic Materials, Inc., Woburn, MA (US)

(72) Inventors: Michael A. Zimmerman, North Andover, MA (US); Alexei B. Gavrilov, Woburn, MA (US)

(21) Appl. No.: 17/467,055

(22) Filed: Sep. 3, 2021

Related U.S. Application Data
(63) Continuation of application No. 15/879,846, filed on Jan. 25, 2018, now Pat. No. 11,114,655.
Application No. 15/879,846 is a continuation-in-part of application No. 15/723,630, filed on Oct. 3, 2017, now Pat. No. 10,741,877.
Application No. 15/723,630 is a continuation-in-part of application No. 15/672,878, filed on Aug. 9, 2017, now Pat. No. 10,811,688.
Application No. 15/672,878 is a continuation-in-part of application No. 15/605,425, filed on May 25, 2017, now Pat. No. 10,559,827.
Application No. 15/605,425 is a continuation-in-part of application No. 15/282,002, filed on Sep. 30, 2016.
Application No. 15/282,002 is a continuation-in-part of application No. 15/148,085, filed on May 6, 2016.
Application No. 15/148,085 is a continuation-in-part of application No. 14/676,173, filed on Apr. 1, 2015, now Pat. No. 11,145,857.
(60) Provisional application No. 62/450,715, filed on Jan. 26, 2017.

(51) Int. Cl. H01M 4/24; H01M 10/26; H01M 10/0565; H01M 4/131; H01M 10/6561; H01M 10/02; H01M 4/50; H01M 4/36; H01M 4/62; H01M 4/26

(52) U.S. Cl. CPC H01M 4/24; H01M 10/26; H01M 10/0565; H01M 4/131; H01M 10/6561; H01M 2004/028; H01M 4/502; H01M 4/366; H01M 4/624; H01M 4/26; H01M 4/50; H01M 10/02

(57) ABSTRACT

An alkaline battery, and a component cathode including a solid ionically conducting polymer material.

### FIELD OF THE INVENTION

The present invention generally relates to an electrochemical battery having a solid ionically conductive polymer material, and more particularly to an alkaline battery and its component cathode.

### BACKGROUND OF THE INVENTION

Typical primary zinc/manganese dioxide (“Zn/MnO₂”) or alkaline batteries can provide good performance on variety of tests, including intermittent service tests, with low material and manufacturing costs. However, battery capacity and hence service life is limited by amount of electrochemically active ingredients such as MnO₂ and zinc which can be packed into the cell.

Therefore, the need for low cost and easy to manufacture alkaline batteries with improved run time in consumer applications is still unfulfilled, and there exists a need for a alkaline battery that can operate a variety of use applications.

### SUMMARY OF THE INVENTION

According to an aspect, an electrochemical alkaline battery with or without an air electrode component which comprises a cathode including a solid ionically conducting polymer material.

In an aspect an alkaline battery comprising: a solid ionically conducting polymer material made by heating a mixture of a polymer and an ionic compound in air.

Further aspects of the alkaline battery are described as follows:

A battery comprising: an electrode that includes: an electrically conductive material, and a solid ionically conducting polymer material; wherein the polymer material is formed by heating a mixture of a polymer and an ionic compound in a gas selected from a group consisting of oxygen, air and ozone and combinations thereof or wherein the gas is independently oxygen, air or ozone.

The battery wherein the ionic conductivity of the solid ionically conducting polymer material is greater than 1×10⁻⁶ S/cm at room temperature, preferably greater than 1×10⁻⁵ S/cm at room temperature, and most preferably greater than 1×10⁻⁴ S/cm at room temperature.

The battery, wherein the electrically conducting material comprises 3-30 percent by weight of the electrode.

The battery, wherein the solid ionically conducting polymer material comprises 1-30 percent by weight of the electrode.

The battery, wherein the electrode further comprises an electrochemically active material comprises 20-80 percent by weight of the electrode.

The battery, wherein the electrode further comprises an oxygen reduction catalyst.

The battery wherein the electrode further comprises manganese dioxide, and the manganese dioxide is selected from a group consisting of β-MnO2 (pyrolusite), ramsdellite, β-MnO2, ε-MnO2, λ-MnO2, EMD, CMD, and combinations thereof.

The battery, wherein the battery is AA (LR6) sized.

The battery, wherein the electrode further comprises an electrochemically active material, and wherein the solid ionically conducting polymer material encapsulates at least one particle of the electrochemically active material.

The battery, wherein the battery has greater than 3 Ah capacity when tested on continuous constant current discharge at current between 150 and 300 mA with 0.8 V voltage cutoff.

The battery, wherein the positive electrode of the battery provides greater than 400 mAhr/g.

The battery, wherein the reactant polymer is polyphenylene sulfide.

The battery, wherein the reactant ionic compound is an inorganic hydroxide.

The battery, wherein the electrically conductive material comprises carbon.

The battery, wherein the ionic compound is lithium hydroxide.

A method of manufacturing an electrode comprising the steps of. Mixing a polymer with an ionic compound to create a first mixture; Heating the first mixture in air in a gas comprising oxygen to form the first mixture into a solid ionically conducting polymer material; Mixing the solid ionically conducting polymer material with an electrically conductive material to make an electrode which can ionically conduct hydroxide ions.

The method, wherein in the heating step the gas comprising oxygen is provided at a positive pressure.

The method, wherein in the making an electrode step the electrode further comprises a solid particulate electrochemically active material, and wherein both the solid ionically conducting polymer material and the electrically conductive material are coated onto the electrochemically active material.

### DETAILED DESCRIPTION OF THE PREFERRED EMBODIMENTS

The present patent application claims priority from U.S. Provisional Patent Application No. 62/450,715, filed Jan. 26, 2017, and is a Continuation-In-Part of U.S. patent application Ser. No. 15/605,425, filed May 25, 2017, U.S. patent application Ser. No. 15/672,878 filed Aug. 9, 2017 and U.S. patent application Ser. No. 15/148,085, filed May 6, 2016 and U.S. patent application Ser. No. 15/282,002 filed Sep. 30, 2016, the disclosures of which are incorporated by reference herein in their entity.

An aspect includes a method of synthesizing a solid ionically conducting polymer material from at least three distinct components: a polymer, a dopant and an ionic compound. The components and method of synthesis are chosen for the particular application of the material. The selection of the polymer, dopant and ionic compound may also vary based on the desired performance of the material. For example, the desired components and method of synthesis may be determined by optimization of a desired physical characteristic (e.g. ionic conductivity).

### Synthesis:

The method of synthesis can also vary depending on the particular components and the desired form of the end material (e.g. film, particulate, etc.). However, the method includes the basic steps of mixing at least two of the components initially, adding the third component in an optional second mixing step, and heating the components/reactants to synthesize the solid ionically conducting polymer material in a heating step. In one aspect of the invention, the resulting mixture can be optionally formed into a film of desired size. If the dopant was not present in the mixture produced in the first step, then it can be subsequently added to the mixture while heat and optionally pressure (positive pressure or vacuum) are applied. All three components can be present and mixed and heated to complete the synthesis of the solid ionically conducting polymer material in a single step. However, this heating step can be done when in a separate step from any mixing or can completed while mixing is being done. The heating step can be performed regardless of the form of the mixture (e.g. film, particulate, etc.). In an aspect of the synthesis method, all three components are mixed and then extruded into a film. The film is heated to complete the synthesis.

When the solid ionically conducting polymer material is synthesized, a color change occurs which can be visually observed as the reactants color is a relatively light color, and the solid ionically conducting polymer material is a relatively dark or black color. It is believed that this color change occurs as charge transfer complexes are being formed, and can occur gradually or quickly depending on the synthesis method.

An aspect of the method of synthesis is mixing the base polymer, ionic compound and dopant together and heating the mixture in a second step. As the dopant can be in the gas phase, the heating step can be performed in the presence of the dopant. The mixing step can be performed in an extruder, blender, mill or other equipment typical of plastic processing. The heating step can last several hours (e.g. twenty-four (24) hours) and the color change is a reliable indication that synthesis is complete or partially complete.

In an aspect of the synthesis method, the base polymer and ionic compound can be first mixed. The dopant is then mixed with the polymer-ionic compound mixture and heated. The heating can be applied to the mixture during the second mixture step or subsequent to the mixing step.

In another aspect of the synthesis method, the base polymer and the dopant are first mixed, and then heated. This heating step can be applied after the mixing or during, and produces a color change indicating the formation of the charge transfer complexes and the reaction between the dopant and the base polymer. The ionic compound is then mixed to the reacted polymer dopant material to complete the formation of the solid ionically conducting polymer material.

Typical methods of adding the dopant are known to those skilled in the art and can include vapor (or gas phase) doping of film containing the base polymer and ionic compound and other doping methods known to those skilled in the art. Upon doping the solid polymer material becomes ionically conductive, and it is believed that the doping acts to activate the ionic components of the solid polymer material so they are diffusing ions.

Other non-reactive components can be added to the above described mixtures during the initial mixing steps, secondary mixing steps or mixing steps subsequent to heating. Such other components include but are not limited to depolarizers or electrochemically active materials such as anode or cathode active materials, electrically conductive materials such as carbons, rheological agents such as binders or extrusion aids (e.g. ethylene propylene diene monomer “EPDM”), catalysts and other components useful to achieve the desired physical properties of the mixture.

Polymers that are useful as reactants in the synthesis of the solid ionically conducting polymer material are electron donors or polymers which can be oxidized by electron acceptors. Semi-crystalline polymers with a crystallinity index greater than 30%, and greater than 50% are suitable reactant polymers. Totally crystalline polymer materials such as liquid crystal polymers (“LCPs”) are also useful as reactant polymers. LCPs are totally crystalline and therefore their crystallinity index is hereby defined as 100%. Undoped conjugated polymers and polymers such as polyphenylene sulfide (“PPS”) are also suitable polymer reactants.

Polymers are typically not electrically conductive. For example, virgin PPS has electrical conductivity of 10⁻²⁰ S cm⁻¹. Non-electrically conductive polymers are suitable reactant polymers.

In an aspect, polymers useful as reactants can possess an aromatic or heterocyclic component in the backbone of each repeating monomer group, and a heteroatom either incorporated in the heterocyclic ring or positioned along the backbone in a position adjacent the aromatic ring. The heteroatom can be located directly on the backbone or bonded to a carbon atom which is positioned directly on the backbone. In both cases where the heteroatom is located on the backbone or bonded to a carbon atom positioned on the backbone, the backbone atom is positioned on the backbone adjacent to an aromatic ring. Non-limiting examples of the polymers used in this aspect of the invention can be selected from the group including PPS, Poly(p-phenylene oxide)(“PPO”), LCPs, Polyether ether ketone (“PEEK”), Polyphthalamide (“PPA”), Polypyrrole, Polyaniline, and Polysulfone. Co-polymers including monomers of the listed polymers and mixtures of these polymers may also be used. For example, copolymers of p-hydroxybenzoic acid can be appropriate liquid crystal polymer base polymers.

Table 2 details non-limiting examples of reactant polymers useful in the synthesis of the solid ionically conducting polymer material along with monomer repeat structure and some physical property information which should be considered also non-limiting as polymers can take multiple forms which can affect their physical properties.

TABLE 2

| | | Melt- | |
|---|---|---|---|
| | | ing | |
| | | Pt. | |
| Polymer | Monomer Structure | (C.) | MW |
| PPS polyphenylene sulfide | 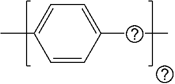 | 285 | 109 |
| PPO Poly(p- phenylene oxide) | 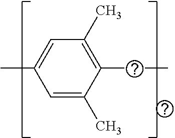 | 262 | 92 |
| PEEK Polyether ether ketone | 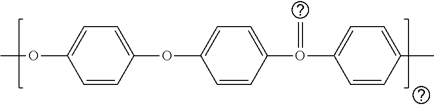 | 335 | 288 |
| PPA Polyphthalamide | 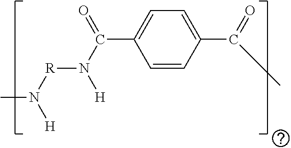 | 312 | |
| Polypyrrole | 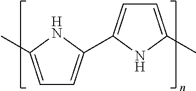 | | |
| Polyaniline Poly- Phenylamine [C₆H₄NH]ₙ | 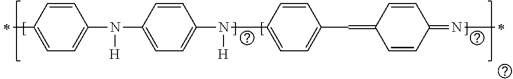 | 385 | 442 |
| Polysulfone | 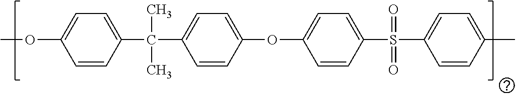 | | 240 |
| Xydar (LCP) | 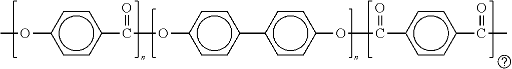 | | |
| Vectran Poly- paraphenylene terephthalamide [—CO—C₆H₄—CO—NH—C₆H₄—NH—]ₙ | 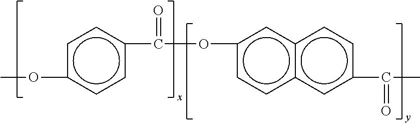 | | |
| Polyvinylidene fluoride (PVDF) | 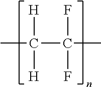 | 177° C. | |
| Polyacrylonitrile (PAN) | 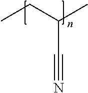 | 300° C. | |
| Polytetrafluoro- ethylene (PTFE) | 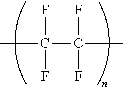 | 327 | |
| Polyethylene (PE) | 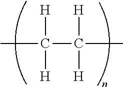 | 115-135 | |

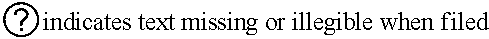

Dopants that are useful as reactants in the synthesis of the solid ionically conducting polymer material are electron acceptors or oxidants. It is believed that the dopant acts to release ions for ionic transport and mobility, and it is believed to create a site analogous to a charge transfer complex or site within the polymer to allow for ionic conductivity. Non-limiting examples of useful dopants are quinones such as: 2,3-dicyano-5,6-dichlorodicyanoquinone (C₈Cl₂N₂O₂) also known as “DDQ”, and tetrachloro-1,4-benzoquinone (C₆Cl₄O₂), also known as chloranil, tetracyanoethylene (C₆N₄) also known as TCNE, sulfur trioxide (“SO₃”), ozone (trioxygen or O₃), oxygen (O₂, including air), transition metal oxides including manganese dioxide (“MnO₂”), or any suitable electron acceptor, etc. and combinations thereof.

In an aspect the dopant can be in the vapor state during synthesis, and under positive pressure. The positive pressure can result in increased ionic conductivity in the synthesized material, and for the dopant group comprising oxygen (i.e. oxygen, air, and ozone), the ionic conductivity can be increased to about or greater than 1×10⁻⁴ S/cm.

The subclass of gas phase dopants oxygen, air and to a lesser extent ozone share an advantage of availability. In an aspect this dopant subclass can be used to reduce manufacturing process steps and associated expense.

Dopants that are temperature stable at the temperatures of the synthesis heating step are useful, and quinones and other dopants which are both temperature stable and strong oxidizers quinones are very useful. Table 3 provides a non-limiting listing of dopants, along with their chemical diagrams.

TABLE 3

| Dopant | Formula | Structure |
|---|---|---|
| 2,3-Dichloro-5,6-dicyano- 1,4-benzoquinone (DDQ) | C₆Cl₂(CN)₂O₂ | 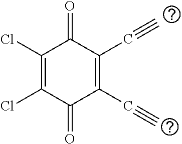 |
| tetrachloro-1,4-benzoquinone (chloranil) | C₆Cl₄O₂ | 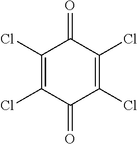 [SMILES: O=C1C(Cl)=C(Cl)C(=O)C(Cl)=C1Cl] |
| Tetracyanoethylene (TCNE) | C₆N₄ | 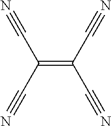 |
| Sulfur Trioxide | SO₃ | |
| Ozone | O₃ | |
| Oxygen | O₂ | |
| Transition Metal Oxides | MxO_{y} (M = Transition Metal, | |
| | x and y are equal to or | |
| | greater than 1) | |

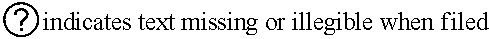

Ionic compounds that are useful as reactants in the synthesis of the solid ionically conducting polymer material are compounds that release desired ions during the synthesis of the solid ionically conducting polymer material. The ionic compound is distinct from the dopant in that both an ionic compound and a dopant are required. Non-limiting examples include Li₂O, LiOH, NaOH, KOH, LiNO₃, Na₂O, MgO, CaCl₂, MgCl₂, AlCl₃, LiTFSI (lithium bis-trifluoromethanesulfonimide), LiFSI (Lithium bis(fluorosulfonyl)imide), Lithium bis(oxalato)borate (LiB(C₂O₄)₂“LiBOB”) and other lithium salts and combinations thereof. Hydrated forms (e.g. monohydride) of these compounds can be used to simplify handling of the compounds. Inorganic oxides, chlorides and hydroxide are suitable ionic compounds in that they dissociate during synthesis to create at least one anionic and cationic diffusing ion. Any such ionic compound that dissociates to create at least one anionic and cationic diffusing ion would similarly be suitable. Multiple ionic compounds can also be useful that result in multiple anionic and cationic diffusing ions can be preferred. The particular ionic compound included in the synthesis depends on the utility desired for the material. For example, in an application where it would be desired to have a hydroxide anion, a lithium hydroxide or other inorganic hydroxide, or an oxide convertible to a hydroxide ion would be appropriate. As would be any hydroxide containing compound that releases a diffusing hydroxide anion during synthesis. A non-limiting group of such hydroxide ionic compounds includes metal. The hydroxide ionic compounds can include alkaline metals, alkaline earth metals, transition metals, and post transition metals in a form that can produce both the desired cationic and anionic diffusing species are appropriate as synthesis reactant ionic compounds.

The purity of the materials is potentially important so as to prevent any unintended side reactions and to maximize the effectiveness of the synthesis reaction to produce a highly conductive material. Substantially pure reactants with generally high purities of the dopant, base polymer and the ionic compound are useful, and purities greater than 98% are more useful with even higher purities, e.g. LiOH: 99.6%, DDQ: >98%, and Chloranil: >990 also useful.

To further describe the utility of the solid ionically conducting polymer material and the versatility of the above described method of the synthesis of the solid ionically conducting polymer material, several classes of the solid ionically conducting polymer material useful for multiple electrochemical applications and distinguished by their application are described:

### Example 1

PPS polymer was mixed with the ionic compound LiOH monohydrate in the proportion of 67% to 33% (by wt.) in an aspect and 10-50 wt % in another aspect, respectively, and mixed using jet milling. The resulting mixture was then heat treated in the presence of air at a temperature between 250 and 350° C. for 30 minutes. Although positive pressure has been found to be useful for synthesis, heat was applied at atmospheric pressure in this example.

A sample of the synthesized solid ionically conducting polymer material (PPS/LiOH/O₂) was placed between stainless steel electrodes in a test fixture. AC impedance (EIS) was recorded in the range from 800 KHz to 100 Hz using Bio-Logic VSP test system to determine the electrolyte conductivity. Ionic conductivity exceeding 1×10⁻⁵ S/cm was found.

The synthesized solid ionically conducting polymer material (PPS/LiOH/O₂) was then sieved to remove agglomerate particles and then mixed with an electrochemically active EMD, electrically conductive carbon and a small amount of potassium hydroxide and then mixed to form a cathode mixture. In an aspect, each particle of the active material, in this case EMD, is coated with the polymer/carbon mixture.

The cathode mixture can be modified to fit the desired application, and the composition ranges detailed in Table 4 describe the mix for cathode alkaline battery applications such as primary and secondary Zinc-MnO2, air-assisted Zinc-MnO2, and Zinc-Air batteries.

TABLE 4

| Component | Wt % |
|---|---|
| Polymer electrolyte | 1-30 |
| EMD | 20-80 |
| KOH | 0-15 |
| Carbon | 3-30 |

Cells can be made using the cathode mixture described in Example 1 according to battery constructions described in US applications U.S. Ser. No. 14/559,430 and U.S. Ser. No. 15/169,160 the specifications of which are incorporated herein by reference.

In addition and specifically: AA air assist cells incorporating the cathode mixture demonstrated greater than 3 Ah capacity during: Continuous constant current discharge at current between 150 and 300 mA with 0.8 V voltage cutoff; Intermittent discharge at current between 150 and 300 mA cutoff applied for 1 hour, followed by 1-hour rest period (0.8V voltage cutoff); Continuous constant current discharge at 50 mA to 1.0V voltage cutoff; Intermittent discharge at 50 mA with applied for 1 hour, followed by 1-hour rest period (1.0V voltage cutoff); Continuous constant resistance discharge at 3.9 Ohm to 0.8V voltage cutoff; Intermittent constant resistance discharge when 3.9 Ohm resistance is applied for 1 hour, followed by 1-hour rest period (0.8V voltage cutoff); Continuous constant resistance discharge of at 42 Ohm to 1.0V voltage cutoff; and Intermittent constant resistance discharge when 42 Ohm resistance is applied for 15 seconds, followed by 45-second rest period (1.0V voltage cutoff). The AA air assist cells also demonstrated cathode capacities exceeding 400 mAh/g, 450 mAh/g, and 500 mAh/g.

Air Cathodes were prepared using the cathode mixture without any traditional catalyst and without EMD. The air cathodes thus prepared showed catalytic activity by reducing oxygen and electrochemical activity by producing useable voltage and amperage when coupled with a traditional zinc anode under load.

While the invention has been described in detail herein in accordance with certain preferred embodiments thereof, many modifications and changes therein may be affected by those skilled in the art without departing from the spirit of the invention. Accordingly, it is our intent to be limited only by the scope of the appending claims and not by way of the details and instrumentalities describing the embodiments shown herein. It is to be understood that variations and modifications can be made on the aforementioned structure without departing from the concepts of the describe aspects, and further it is to be understood that such concepts are intended to be covered by the following claims unless these claims by their language expressly state otherwise.

What is claimed is:

1. A battery comprising: an electrode that includes: an electrically conductive material, and a solid ionically conducting polymer material; wherein the polymer material is formed by heating a mixture of a polymer and an ionic compound in a gas selected from a group consisting of oxygen, air and ozone.

2. The battery of claim 1, wherein the gas comprises oxygen.

3. The battery of claim 1, wherein the gas comprises ozone.

4. The battery of claim 1, wherein the gas comprises air.

5. The battery of claim 1, wherein the electrically conducting material comprises 3-30 percent by weight of the electrode.

6. The battery of claim 1, wherein the solid ionically conducting polymer material comprises 1-30 percent by weight of the electrode.

7. The battery of claim 1, wherein the electrode further comprises an electrochemically active material comprises 20-80 percent by weight of the electrode.

8. The battery of claim 1, wherein the electrode further comprises an oxygen reduction catalyst.

9. The battery of claim 1 wherein the electrode further comprises manganese dioxide, and the manganese dioxide is selected from a group consisting of β-MnO2 (pyrolusite), ramsdellite, γ-MnO2, ε-MnO2, λ-MnO2, EMD, CMD, and combinations thereof.

10. The battery of claim 1, wherein the battery is AA (LR6) sized.

11. The battery of claim 1, wherein the electrode further comprises an electrochemically active material, and wherein the solid ionically conducting polymer material encapsulates at least one particle of the electrochemically active material.

12. The battery of claim 10, wherein the battery has greater than 3 Ah capacity when tested on continuous constant current discharge at current between 150 and 300 mA with 0.8 V voltage cutoff.

13. The battery of claim 10, wherein the positive electrode of the battery provides greater than 400 mAhr/g.

14. The battery of claim 1, wherein the polymer is polyphenylene sulfide.

15. The battery of claim 1, wherein the ionic compound is an inorganic hydroxide.

16. The battery of claim 1, wherein the electrically conductive material comprises carbon.

17. The battery of claim 1, wherein the ionic compound is lithium hydroxide.

18. The battery of claim 1, wherein the ionic conductivity of the solid ionically conducting polymer material is greater than 1×10⁻⁶ S/cm at room temperature.

19. A method of manufacturing an electrode comprising the steps of:
mixing a polymer with an ionic compound to create a first mixture;
heating the first mixture in air in a gas comprising oxygen to form the first mixture into a solid ionically conducting polymer material;
mixing the solid ionically conducting polymer material with an electrically conductive material to make an electrode which can ionically conduct hydroxide ions.

20. The method of claim 19, wherein in the heating step the gas comprising oxygen is provided at a positive pressure.
